(19) United States
(12) Patent Application Publication
(10) Pub. No.: US 2004/0205046 A1
(43) Pub. Date: Oct. 14, 2004

(54) Indexing and retrieval of textual collections on PDAS

(75) Inventors: Doron Cohen, Misqau (IL); Michael Herscovici, Haifa (IL); Aya Soffer, Haifa (IL); Yoelle Maarek-Smadja, Haifa (IL)

Correspondence Address: Stephen C. Kaufman, Intellectual Property Law Dept., IBM Corporation, P.O. Box 218, Yorktown Heights, NY, 10598, US

(73) Assignee: International Business Machines Corporation, Armonk, NY (US)

(21) Appl. No.: 09/997,511

(22) Filed: Nov. 29, 2001

(51) Int. Cl. G06F 17/00

(52) U.S. Cl. 707/3; 715/513

(57) ABSTRACT

A method for indexing text on a personal digital assistant (PDA). The method may include the steps of transferring dynamic documents from the PDA to an off line mediary, creating off-line, from the dynamic documents, a static index and transferring the off-line static index to the PDA. The off-line mediary may be a mediary, such as a desktop, a server, and a web server.

### FIELD OF INVENTION

The present invention relates generally to a method and apparatus for facilitating retrieval of data on personal digital assistants, and in particular, for retrieval and indexing of static and dynamic text.

### BACKGROUND

Personal digital assistants (PDAs) are being used more and more often as information appliances, and as a consequence, may store a great deal of textual content such as reference books, etc. For large collections of data, i.e. of up to several Mbytes, the typical PDA sequential string search utility is not adequate since it is ordinarily very slow and lacks many features such as stemming, ranking by relevance, etc. In order to provide such features on a PDA, it is necessary to use a fully developed text search engine with state-of-the-art algorithms for storing, indexing, and searching. However, because PDAs have limited CPU and storage capabilities, it is not feasible to install and run fully developed search engines. It is therefore desirable to have search facilities that are quick and size efficient.

### SUMMARY

The present invention may provide an improved method and apparatus for retrieval and indexing of data on a PDA.

There is therefore provided in accordance with an embodiment of the present invention, a method for indexing text on a personal digital assistant (PDA). The method may include the steps of transferring dynamic documents from the PDA to an off line mediary, creating off-line, from the dynamic documents, a static index and transferring the off-line static index to the PDA. The off-line mediary may be a mediary such as a desktop, a server, or a web server.

Some embodiments may further include the steps of updating the off-line static index with the dynamic documents that have been modified, added, or deleted after the step of creating, and from time to time, transferring the off-line updated static index to the PDA. The transfer which occurs from time to time may occur during synchronization of the PDA with the off-line mediary. Alternatively, the method may include the step of indexing on-line a dynamic index of the dynamic documents.

There is therefore provided in accordance with an alternative embodiment of the present invention, a method for searching text on a personal digital assistant (PDA). The method may include the steps of searching an on-line static index and compiling therefrom static search results, searching a dynamic index and compiling therefrom dynamic search results and merging the static search results with the dynamic search results.

There is therefore provided in accordance with an alternative embodiment of the present invention, a method for indexing and searching text on a personal digital assistant (PDA). the method may include the steps of creating off-line a static index of dynamic documents for transfer to the PDA, and searching on the PDA, the static index and an on-line dynamic index, wherein the step of creating is independent from the of searching.

There is therefore provided in accordance with an alternative embodiment of the present invention, a method for indexing text on a personal digital assistant (PDA), the method may include the steps of creating off-line a static index, transferring the off-line static index to the PDA, from time to time, updating the off-line static index with dynamic text from the PDA, and updating the on-line static index with the updated off-line static index. The dynamic text may be text on the PDA that has been added or modified after the step of creating.

In an alternative embodiment, the method may further include the step of creating an on-line dynamic index from the dynamic text. Alternatively, the method may further include the steps of detecting when the dynamic index exceeds predefined limits, and sending a signal. The signal may including a warming to generate a new, merged static index. The predefined limits may be either predefined limits for search time, document capacity, or number of dynamic document.

There is therefore provided in accordance with an alternative embodiment of the present invention, a personal digital assistant (PDA) including an updatable static index and a dynamic index. The updatable static index may be created off-line.

The PDA may further include a search engine for searching the static index and the dynamic index, or may include an on-line indexer for creating the dynamic index.

### BRIEF DESCRIPTION OF FIGURES

The present invention will be understood and appreciated more fully from the following detailed description taken in conjunction with the appended drawings in which:

FIG. 1 is a block diagram representing an indexing system constructed and operative in accordance with a preferred embodiment of the present invention;

FIGS. 2A-2E are block diagrams illustrating alternative indexing modes, constructed and operative in accordance with a preferred embodiment of the present invention; and

FIG. 3 is a block diagram illustrating a search mode constructed and operative in accordance with a preferred embodiment of the present invention.

### DETAILED DESCRIPTION INVENTION

The present invention is a method and apparatus for retrieval and indexing of data on a PDA. An embodiment of the present invention comprises the steps of uploading data files from a personal digital assistant (PDA) to a mediary, performing off-line, at the mediary, static indexing, and downloading the static index from the mediary to the PDA. This procedure may be repeated from time to time, such as during sync. As an example, the mediary may be a desktop, a server or a webserver.

For the purposes herein, off-line is defined as an entity separate from the PDA, or a process which is not performed on the PDA.

The present invention therefore provides a PDA comprising a static index, and the ability to update such index with dynamic data from the PDA. Prior art systems may allow for static indexes to be imported onto handheld devices, however, there does not exist method or apparatus for updating the imported static index with dynamic data from the PDA.

The present invention may therefore decouple the static indexing process from the search process. This decoupling may move some of the more CPU intensive processes, namely indexing, to the mediary. It is apparent to those skilled in the art that the present invention may thereby save time and may reduce PDA memory space requirements.

The present invention additionally enables search and/or retrieval in a PDA modifiable text collection, the collection may have attached thereto an index. The index may be a merge of the static index and a dynamic, and/or simpler index. The dynamic index may be created by an on-line indexer from dynamic documents that have been added or modified since the last creation (e.g. sync) of the static index.

Elements of the present invention may detect when the dynamic index becomes too large, therefore affecting efficiency, and may warn the user. In some embodiments, the present invention may recommend performing a sync to generate a new static index, and subsequently clearing the dynamic index.

The present invention teaches these concepts separately, and/or in combination with other elements listed hereinbelow. It is noted that although herein references are made to PDAs, other devices capable of communications but have limited system resources, such as handheld devices, are also applicable.

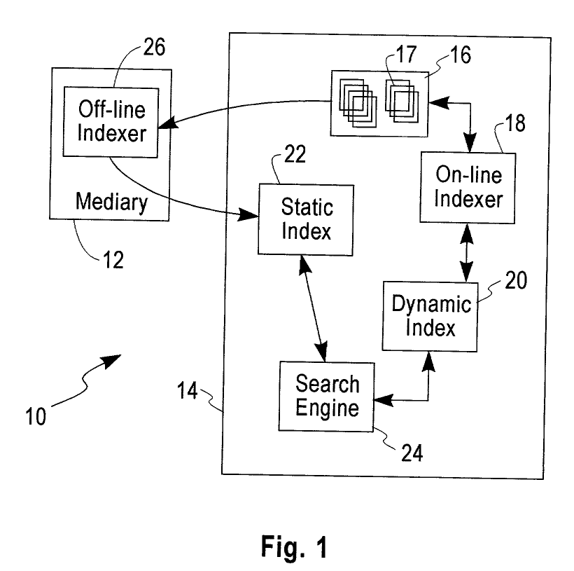

Reference is now made to FIG. 1, a system architecture drawing illustrating the elements and operations of indexing and retrieval system 10. System 10 may comprise a mediary 12, comprising therein an off-line indexer 26, and a handheld device, known herein as PDA 14. From time to time mediary 12 and PDA 14 may be synchronized.

Mediary 12 may be any type of processor or system that may communicate or synchronize with PDA 14. Typically mediary 12 may be superior to PDA 14 in terms of space and computing power. Mediary 12 may be a desktop computer, a web server, or any other server.

PDA 14 may comprise data 16, an on-line indexer 18, a dynamic index 20, a static index 22, and a search engine 24. Data 16 may comprise or store data files, such as text files, documents, records, appointments, to do lists, charts, etc. Typically the data files may be time stamped when a document activity occurs such as creation, deletion, modification, etc. For purposes of clarity, documents time stamped after the last sync between mediary 12 and PDA 14 are referred to herein as dynamic documents 17. On-line indexer 18 may process data 16, creating and/or updating dynamic index 20.

Static index 22 may typically be an inverted index. Alternatively, dynamic index 20 may also be an inverted index. Search engine 24, upon request for a search, may search both static index 22 and dynamic index 20, and may activate on-line indexer 18.

Hereinbelow, in the relevant labeled sections, are more detailed descriptions of some of the selected operations of system 10.

Off-Line Indexing—Sync

Upon command to sync, data 16 may be uploaded from PDA 14 to mediary 12. Offline indexer 26 may process the data, creating static index 22, and may subsequently download static index 22 to PDA 14.

If static index 22 currently exists on PDA 14, the downloaded static index 22 may replace that currently existing index. In such a manner, the static index 22 on PDA 14 is updated, or replaced, during sync with the most recently off-line created static index 22. Dynamic index 20 may then be cleared.

It is noted that by moving the static indexing operation off-line to mediary 12, it may be possible to use larger, faster static indexers than would be possible if attempting to do an on-line indexing (on PDA 14).

In an alternative embodiment, if at least one sync has been performed, data 16 may upload to mediary 12 only dynamic documents 17. Off-line indexer 26 may then create a delta index associated with only those dynamic documents 17. Indexer 26 may update the static index 22 with the delta index.

On-Line Indexing

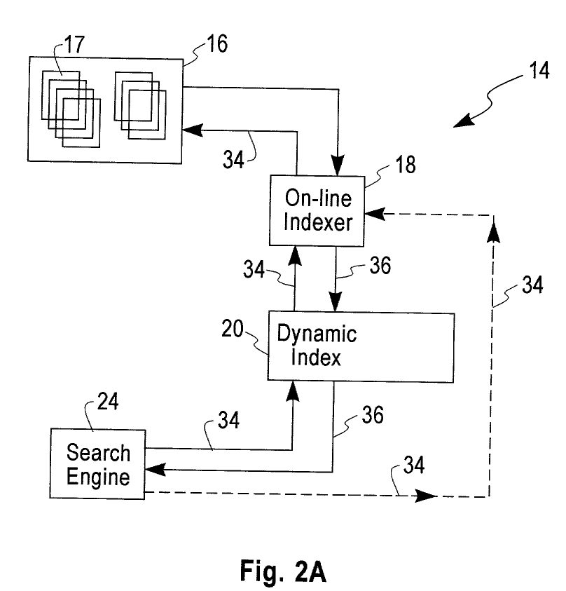

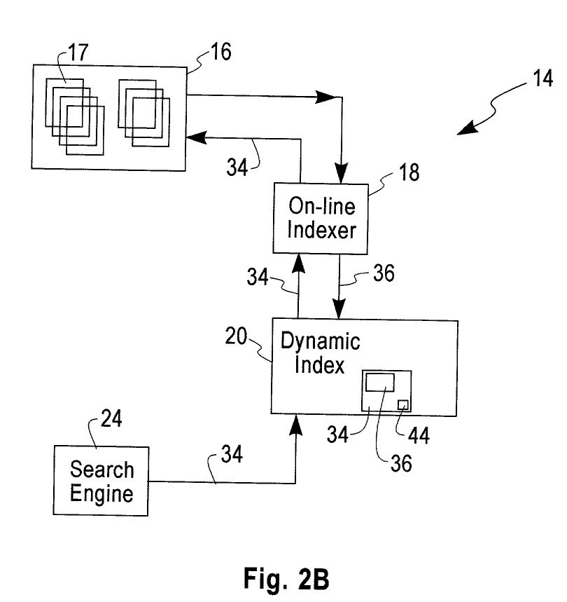

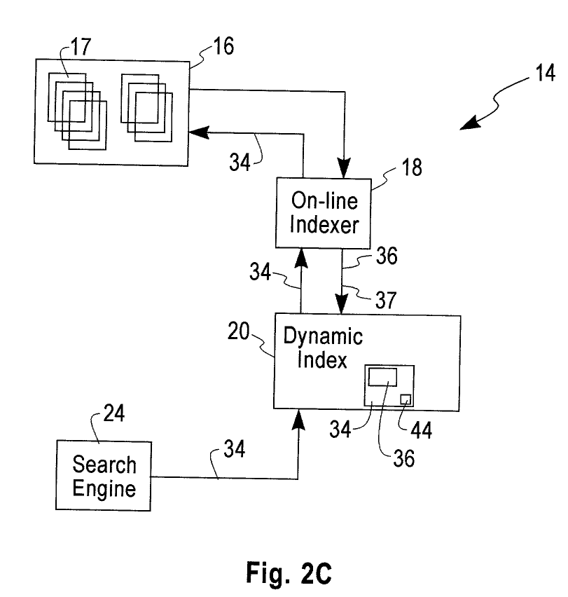

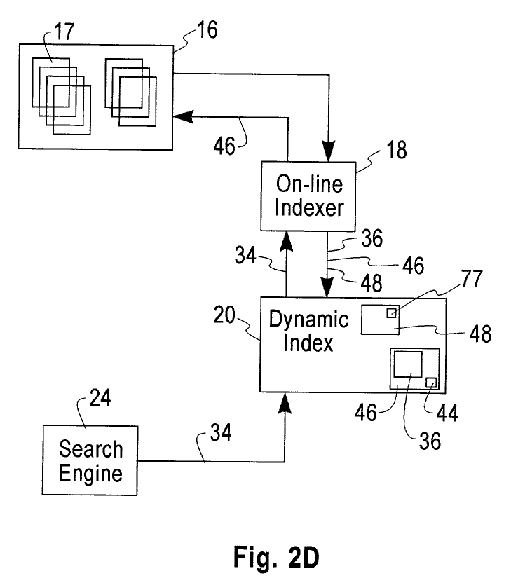

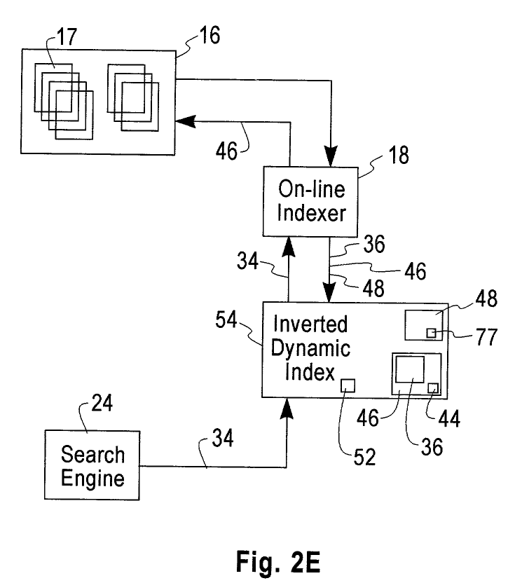

Reference is now made to FIGS. 2A-2E, illustrations of alternative methods for indexing, operated and constructed according to the present invention.

Illustrated in FIG. 2A is an on-line indexing method known herein as lazy mode. In the lazy mode, on-line indexer 18 may be invoked only when a query is issued, as follows: Search engine 24 queries indexer 18 with a query term 34. Indexer 18 may scan data 16, computing a list of dynamic files/documents 17.

On-line indexer 18 may then scan dynamic files 17 searching for occurrences of the query terms 34, and creating therefrom associated dynamic search results 36. This is known as a linear string match search, and typically only a relatively small set of the documents is searched in this manner.

It is noted that in the lazy mode, indexer 18 may not save dynamic search results 36. In such instances the use of dynamic index 20 may be optional and, search engine 24 may communicate directly with on-line indexer 18.

In contrast to the lazy mode, in an alternative method, a lazy and cached mode illustrated in FIG. 2B, the queried terms 34 and their associated dynamic search results 36 may be maintained in dynamic index 20.

An exemplary lazy and cached operation may be as follows: Search engine 24 may query dynamic index 20 with a query term 34. As an example, query term 34 is not found in dynamic index 20. The query may be passed onto on-line indexer 18, which may search data 16, compute a list of dynamic documents 17, scan for occurrences of the query terms 34, and create therefrom associated dynamic search results 36. In the present mode, a timestamp 44 may be attached to each such queried term 34. The queried term 34 with the attached time stamp 44, and the associated dynamic search results 36 may then be stored in dynamic index 20.

In an alternative example of the lazy and cached mode, illustrated in FIG. 2C, search engine 24 may query dynamic index 20 with query term 34, and finds in dynamic index 20 occurrences of previous queries for query term 34. Search engine 24 notes the time stamp 44 attached to the previously queried term 34, and may request from on-line indexer 18 to scan in data 16 only those dynamic documents 17 which have been added, and/or modified since the time on time stamp 44. On-line indexer 18 may do so, creating therefrom delta dynamic search results 37.

The delta dynamic search results 37 may be transferred to dynamic index 20 and merged with the dynamic search results 36. The dynamic search results 36 may then be updated. The time stamp 44 of the associated previously queried term 34 may then be updated accordingly.

In some instances a dynamic document 17 may have been deleted from data 16, and note of the deletion may be comprised in the delta search results 37. As such, when delta search results 37 are merged with dynamic search results 36, references to the deleted dynamic document 17 may be removed from dynamic search results 36. The time stamps 44 of the associated previously queried term 34 may then be updated accordingly.

Similar to the lazy method, the lazy and cached mode is also a linear string match search, but an even smaller set of documents is searched. It is noted that searches in this mode may be especially efficient since previously queried terms 34 and associated dynamic results 36 may be stored in dynamic index 20.

FIG. 2D is an illustration of yet another on-line indexing method, known as a cached stems mode, wherein the issue of string matching search is addressed. In prior art, on-line indexers string matched searches may lack accuracy. In the present embodiment of the present invention, accuracy may be improved via the creation of stem documents 48.

As an example, on-line indexer 18 receives a query term 34. Indexer 18 stems query term 34 creating stemmed term 46 and attaching thereto a time stamp 44. On-line indexer 18 may then scan dynamic files 17 in data 16. If this is the first time dynamic documents 17 have been scanned, all the words in dynamic documents 17 are stemmed, creating stem documents 48, and attaching thereto time stamp 77. In conjunction with the present embodiment, the mode illustrated in FIG. 2B may be performed, resulting in dynamic results 36.

Stem documents 48 with associated time stamp 77, stemmed terms 46 with associated time stamps 44, and results 36 may be stored in dynamic index 20. As is apparent to those skilled in the art, that the major part of the time cost is associated with the first time stemming of the dynamic document 17.

In a subsequent query, a scan of data 16 may reveal that a dynamic document 17 has modified and/or added after the time of time stamp 44 attached to associated stem term 46. If document 17 is also revealed to have been modified after the time of time stamp 77 attached to associated stem document 48, then document 17 may be re-stemmed, and the stem document 48 may be updated. The associated time stamp 77 may then be updated accordingly.

Via the usage of stem documents 48, accuracy of the linear search may be improved, with reasonable time cost, but at the price of an increased index size.

In some embodiments of the present invention, illustrated in FIG. 2E, PDA 14 may comprise an inverted dynamic index 54, comprising therein a dynamic document list 52. Dynamic inverted index 54 may perform the same functions as dynamic index 20 described herein above.

List 52 may comprise a listing of those dynamic documents 17 which have been modified, added or deleted since the last sync, e.g. since the creation of the last static index 22. List 52 may be created by on-line indexer 18.

Inverted index 54 may have the same structure as that of the static index 22, however, it may be smaller, comprising the index of only the dynamic documents 17 added or modified since the last creation of static index 22.

When dynamic index 54 is invoked, it may request that on-line indexer 18 perform an update of dynamic documents list 52. If the updated list 52 is different from the currently held list 52, inverted index 54 may first be updated before performing the query process, and the updated list 52 may replace the currently held list 52. As is apparent to those skilled in the art, search in the presently described inverted index mode may be usually fast, however the speed may be countered by the space and time cost required to update index 54 .

It is noted that the process of creating the dynamic documents list 52 may also include stemming of the dynamic documents 17.

Search Engine

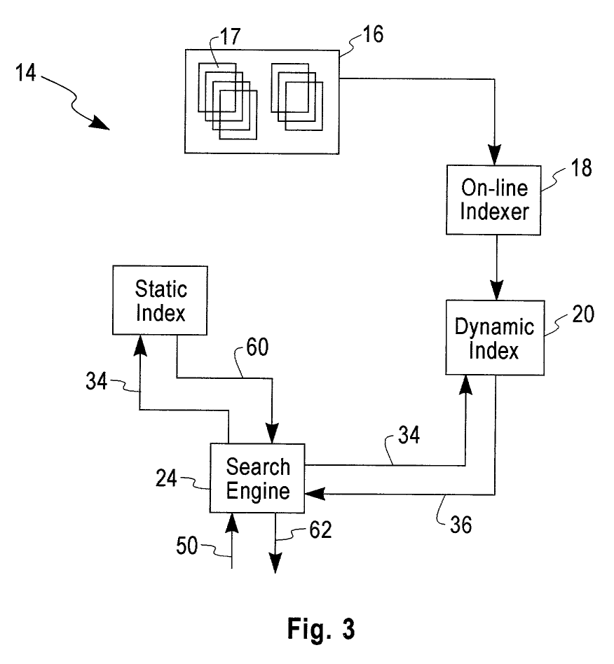

It is commonly known that static indexes are easier and faster to search than dynamic indexes. The present invention, via decoupling of old files from the new files, e.g. via usage of both static index 22 and dynamic index 20, may provide an effective, quick search. It is noted that although hereinbelow references are made to dynamic index 20, usages of inverted dynamic index 54 may also be implied. Reference is now made to FIG. 3, an illustration of an exemplary search according to an embodiment of the present invention. Search-engine 24 may receive an input query 50 comprising query terms 34. Search engine 24 may first search in static index 22 for each query terms 34, creating therefrom a results list 60. Results list 60 may comprise a listing of the documents from static index 22 which comprise occurrences of queried term 34.

Search engine 24 may then search in dynamic index 20 for query terms 34. On-line indexer 18 may then be queried with the query terms 34, and a process such as that described above in reference to FIGS. 2A-2E may be performed. The indexing processes of FIGS. 2A-2E are described in detail hereinabove, and will not be repeated hereinbelow.

The dynamic results 36 returned by the on-line indexer 18 to dynamic index 20. Results list 60 may then be compared to dynamic results 36.

a) If a document appears in both results list 60 and in dynamic results 36, the document listing may be retained, however, dynamic results 36 may be removed from the results list 60.

b) If a dynamic document 17 has been deleted from data 16 post creation of static index 22, results list 60 may list the deleted document, however dynamic results 36 may not list the deleted document. Alternatively, dynamic results 36 may list the document as being deleted. After comparison of list 60 with dynamic results 36, the listing of the deleted document may be removed from results list 60.

It is noted that the above processes are explained in reference to dynamic results 36, however references to data 16 or dynamic document list 52 may also be implied, where applicable.

Dynamic results 36 may then be merged with results list 60, creating a results list 62. Results list 62 may be outputted by PDA 14. Results list 62 may comprise or be accompanied by document search scores. In alternative embodiments, search engine 24 may update document scores appropriately. Search engine 24 may also perform alternative functions such as a scores merge or an inefficient warning. Typically static index 22 may be larger than the dynamic index 20. Hence, for query terms 34 that are found in both static index 22 and dynamic index 20, the (inverse-document-frequency) IDF of static index 22 may be used when merging and/or updating the scores of the result documents. As is apparent to those skilled in the art, use of the IDF may improve search result accuracy.

For terms 34 found only in the dynamic index 22, either the IDF of dynamic index 22 or a predefined average value may be used.

From time to time dynamic index 20 may become too large and efficiency may decline. In such instances, it may be desirable to issue a warning , and/or recommend that a sync be performed to generate a new, merged static index. Search engine 24 may apply several parameters in the calculation of such a decision. These parameters may include the time it takes to perform a search, the total number of dynamic documents held in data 16, and/or the number of dynamic documents that are being searched or indexed by on-line indexer 18 (i.e. excluding deleted documents), etc. As an example, if the current value for any of these parameters exceeds a predefined threshold, a warning may be produced. While other similar parameters can be devised, herein is only a representing list of the possible options. It will be appreciated by persons skilled in the art that the present invention is not limited by what has been particularly shown and describe herein above. As such, other possible approaches may include integration of the above methods and apparatus within the hand held operating systems. Rather, the scope of the invention may be defined by the claims which follow:

1. A method for indexing text on a personal digital assistant (PDA), the method comprises the steps of:
transferring dynamic documents from said PDA to an off line mediary;
creating off-line, from said dynamic documents, a static index; and
transferring said off-line static index to said PDA.

2. A method according to claim 1, wherein said mediary is selected from the group consisting of a desktop, a server, and a web server.

3. A method according to claim 1, further comprising the step of:
updating said off-line static index with said dynamic documents that have been modified, added, or deleted after said step of creating, and
from time to time, transferring said off-line updated static index to said PDA.

4. A method according to claim 3, wherein said from time to time is synchronization of said PDA with said off-line mediary.

5. A method according to claim 1, further comprising the step of:
indexing on-line a dynamic index of said dynamic documents.

6. A method for searching text on a personal digital assistant (PDA), the method comprises the steps of:
searching an on-line static index and compiling therefrom static search results;
searching a dynamic index and compiling therefrom dynamic search results; and
merging said static search results with said dynamic search results.

7. A method for indexing and searching text on a personal digital assistant (PDA), the method comprises the steps of:
creating off-line a static index of dynamic documents for transfer to said PDA; and
searching on said PDA, said static index and an on-line dynamic index, wherein said step of creating is independent from said of searching.

8. A method for indexing text on a personal digital assistant (PDA), the method comprises the steps of:
creating off-line a static index;
transferring said off-line static index to said PDA;
from time to time, updating said off-line static index with dynamic text from said PDA; and
updating said on-line static index with said updated off-line static index.

9. A method according to claim 8, wherein said dynamic text is text on said PDA that has been added or modified after said step of creating.

10. A method according to claim 8, further comprising the step of:
creating an on-line dynamic index from said dynamic text.

11. A method according to claim 8, further comprising the steps of:
detecting when the dynamic index exceeds predefined limits; and
sending a signal.

12. A method according to claim 11, wherein said signal comprising a warming to generate a new, merged static index.

13. A method according to claim 12, wherein said predefined limits are selected from the group consisting of predefined limits for search time, document capacity, or number of dynamic document.

14. A personal digital assistant (PDA) comprising:
an updatable static index; and
a dynamic index.

15. A PDA according to claim 14, wherein said updatable static index is created off-line.

16. A PDA according to claim 14, further comprising:
a search engine for searching said static index and said dynamic index.

17. A PDA according to claim 14, further comprising:
an on-line indexer for creating said dynamic index.
